(19) United States
(12) Patent Application Publication
(10) Pub. No.: US 2026/0218908 A1
(43) Pub. Date: Jul. 30, 2026

(54) COMBUSTOR, COMBUSTOR SYSTEM, AND GAS TURBINE

(71) Applicant: MITSUBISHI HEAVY INDUSTRIES, LTD., Tokyo (JP)

(72) Inventors: Hiroshi Makigano, Tokyo (JP); Shinichi Fukuba, Tokyo (JP); Naoki Oyama, Tokyo (JP); Koichi Tanimoto, Takasago City (JP)

(73) Assignee: MITSUBISHI HEAVY INDUSTRIES, LTD., Tokyo (JP)

(21) Appl. No.: 19/151,868

(22) PCT Filed: Nov. 21, 2023
(86) PCT No.: PCT/JP2023/041841

§ 371 Date: Jul. 29, 2025

(30) Foreign Application Priority Data
Mar. 30, 2023 (JP) 2023-054549

(51) Int. Cl. F23R 3/28; F02C 3/04

(52) U.S. Cl. CPC F23R 3/286; F02C 3/04

(57) ABSTRACT

A combustor includes: a substrate that extends in a direction orthogonal to a combustor axis; a plurality of premixing pipes that extend to penetrate the substrate and that jet a premixed gas generated by mixing a fuel with air, which is introduced from an upstream side, from an opening portion on a downstream side; and a temperature detection circuit that is provided on the substrate and that extends in the direction orthogonal to the combustor axis to pass around each of the premixing pipes. The temperature detection circuit has a starting point and an end point that are output terminals of the temperature detection circuit and has a plurality of contact points formed by alternately connecting a plurality of positive element lines and a plurality of negative element lines from a starting point side toward an end point side.

### TECHNICAL FIELD

The present disclosure relates to a combustor, a combustor system, and a gas turbine.

Priority is claimed on Japanese Patent Application No. 2023-54549 filed on Mar. 30, 2023, the content of which is incorporated herein by reference.

### BACKGROUND ART

For example, PTL 1 discloses a cluster combustor that is an example of a combustor used in a gas turbine.

The cluster combustor has a large number of premixing pipes that are arranged side by side and into which air is introduced. The air introduced into the premixing pipe is mixed with the fuel and is ejected as a premixed gas from an opening portion of the premixing pipe on a downstream side. In this case, the premixed gas is ignited, so that a plurality of small flames are formed at an outlet of each of the premixing pipes.

### CITATION LIST

### Patent Literature

[PTL 1] US Unexamined Patent Application Publication No. 2013/0232979

### SUMMARY OF INVENTION

### Technical Problem

In the combustor as described above, flashback, which is a flame flowing back along a wall surface in the premixing pipe, occurs in some cases. The flashback occurs locally in the identified premixing pipe in some cases, and in order to detect the flashback, it is necessary to install a large number of sensors according to the number of premixing pipes.

The present disclosure has been devised in order to solve the problems, and an object thereof is to provide a combustor, a combustor system, and a gas turbine in which flashback can be detected with a simple configuration.

### Solution to Problem

According to an aspect of the present disclosure, in order to solve the problems, there is provided a combustor including a substrate that extends in a direction orthogonal to a combustor axis, a plurality of premixing pipes that extend to penetrate the substrate and that jet a premixed gas generated by mixing a fuel with air, which is introduced from an upstream side, from an opening portion on a downstream side, and a temperature detection circuit that is provided on the substrate and that extends in the direction orthogonal to the combustor axis to pass around each of the premixing pipes, in which the temperature detection circuit has a starting point and an end point that are output terminals of the temperature detection circuit and has a plurality of contact points formed by alternately connecting a plurality of positive element lines and a plurality of negative element lines from a starting point side toward an end point side.

According to another aspect of the present disclosure, there is provided a combustor system including the combustor and a calculation device that detects flashback based on a voltage value output from the output terminal.

According to still another aspect of the present disclosure, there is provided a gas turbine including a compressor that compresses air, the combustor system, into which the air is introduced to generate a combustion gas, and a turbine that is driven by the combustion gas.

### Advantageous Effects of Invention

With the combustor, the combustor system, and the gas turbine of the present disclosure, flashback can be detected with a simple configuration.

### BRIEF DESCRIPTION OF DRAWINGS

FIG. 1 is a schematic view showing a schematic configuration of a gas turbine according to a first embodiment of the present disclosure.

FIG. 2 is a vertical sectional view showing a schematic configuration of a combustor in a combustor system according to the first embodiment of the present disclosure.

FIG. 3 is a view of the combustor of the combustor system according to the first embodiment of the present disclosure, which is viewed from a downstream side.

FIG. 4 is a schematic view showing a principle of a temperature detection circuit of the combustor of the combustor system according to the first embodiment of the present disclosure.

FIG. 5 is a functional block diagram of a calculation device of the combustor system according to the first embodiment of the present disclosure.

FIG. 6 is a flowchart showing a flow of processing of the calculation device of the combustor system according to the first embodiment of the present disclosure.

FIG. 7 is a view of a combustor of a combustor system according to a second embodiment of the present disclosure, which is viewed from a downstream side.

FIG. 8 is a schematic view showing a principle of a temperature detection circuit of the combustor of the combustor system according to the second embodiment of the present disclosure.

FIG. 9 is a view of a combustor of a combustor system according to a third embodiment of the present disclosure, which is viewed from a downstream side.

FIG. 10 is a functional block diagram of a calculation device of the combustor system according to the third embodiment of the present disclosure.

FIG. 11 is a flowchart showing a flow of processing of the calculation device of the combustor system according to the third embodiment of the present disclosure.

FIG. 12 is a view of a combustor of a combustor system according to a fourth embodiment of the present disclosure, which is viewed from a downstream side.

FIG. 13 is a functional block diagram of the calculation device of the combustor system according to the fourth embodiment of the present disclosure.

FIG. 14 is a flowchart showing a flow of processing of the calculation device of the combustor system according to the fourth embodiment of the present disclosure.

FIG. 15 is a vertical sectional view showing a schematic configuration of a combustor in a combustor system according to a fifth embodiment of the present disclosure.

FIG. 16 is a partially enlarged view of FIG. 14.

FIG. 17 is a cross-sectional view taken along line A-A of FIG. 15.

FIG. 18 is a view showing a combustor according to a modification example of the fifth embodiment.

FIG. 19 is a hardware configuration view of the calculation device according to each of the embodiments of the present disclosure.

### DESCRIPTION OF EMBODIMENTS

### First Embodiment

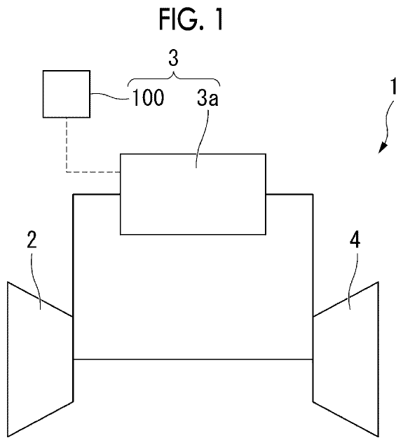

Hereinafter, a first embodiment of the present invention will be described in detail with reference to FIGS. 1 to 6.

As shown in FIG. 1, a gas turbine 1 according to the present embodiment has a compressor 2 that compresses air A, a combustor 3a that generates a combustion gas C, and a turbine 4 that is driven by the combustion gas C.

A plurality of combustors 3a are provided at intervals in a circumferential direction around a rotary shaft of the gas turbine 1. The combustor 3a mixes a fuel F with the air A compressed by the compressor 2 to combust the mixture and generates the high-temperature and high-pressure combustion gas C.

### <Combustor>

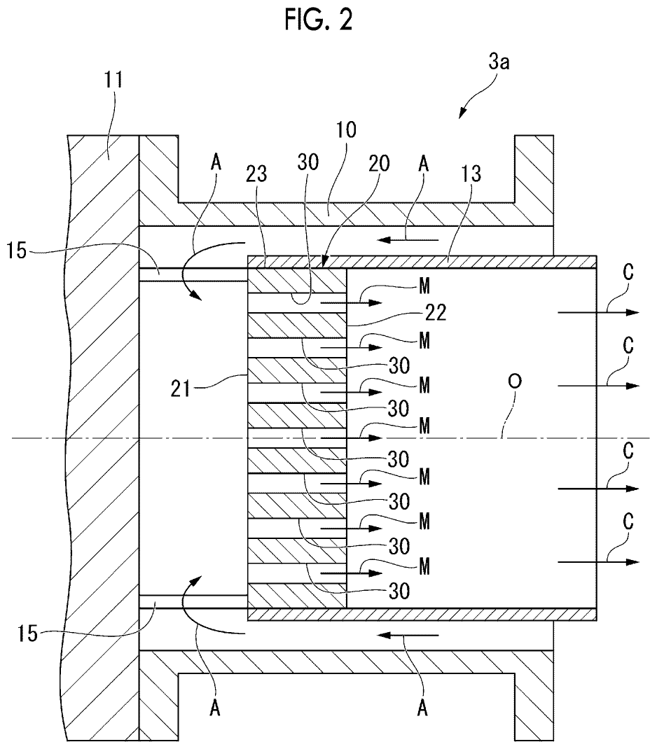

Hereinafter, a configuration of the combustor 3a will be described with reference to FIGS. 2 to 6.

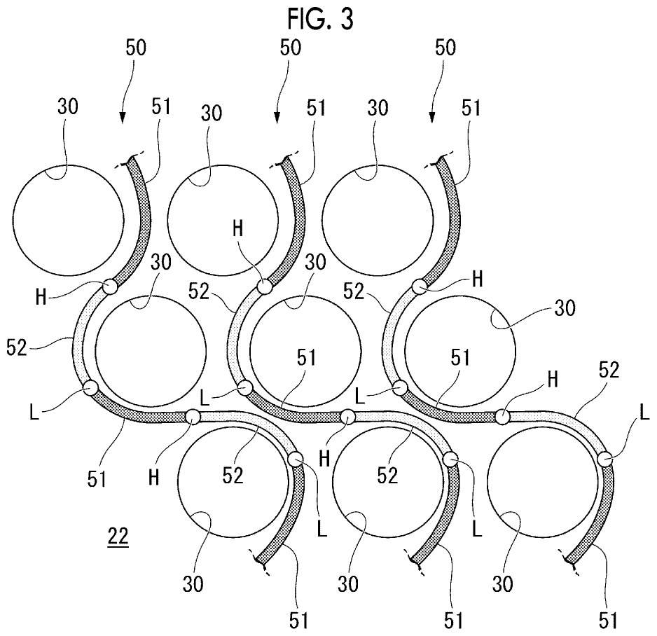

As shown in FIG. 2, the combustor 3a has an outer cylinder 10, an end cover 11, an inner cylinder 13, a support unit 15, a substrate 20, and a temperature detection circuit 50 (see FIG. 3).

### <Outer Cylinder>

The outer cylinder 10 has a cylindrical shape centered on an axis O (combustor axis O) that is the center of the combustor 3a.

### <End Cover>

The end cover 11 has a disk shape that closes an end portion of the outer cylinder 10 on one side (left side in FIG. 2) in a direction of the axis O. The end portion of the outer cylinder 10 on the one side in the direction of the axis O is brought into contact with the end cover 11.

### <Inner Cylinder>

The inner cylinder 13 is disposed coaxially inside the outer cylinder 10. The inner cylinder 13 has a cylindrical shape extending in the direction of the axis O inside the outer cylinder 10. An end portion of the inner cylinder 13 on the one side in the direction of the axis O is separated from the end cover 11 in the direction of the axis O. An outer diameter of the inner cylinder 13 is smaller than an inner diameter of the outer cylinder 10. Accordingly, an annular flow path is formed between an outer peripheral surface 23 of the inner cylinder 13 and an inner peripheral surface of the outer cylinder 10. The air A compressed by the compressor 2 circulates in the flow path toward the one side in the direction of the axis O from the other side (right side in FIG. 2) in the direction of the axis O.

### <Support Unit>

The support unit 15 is a member extending in the direction of the axis O, and a plurality of support units 15 are provided at intervals in the circumferential direction. An end portion of the support unit 15 on the one side in the direction of the axis O is fixed to a surface of the end cover 11, which faces the other side in the direction of the axis O, on an inner peripheral side of the outer cylinder 10. When the air A circulating between the outer cylinder 10 and the inner cylinder 13 to the one side in the direction of the axis O passes between the support units 15 adjacent to each other, a circulation direction is reversed to the other side in the direction of the axis O.

### <Substrate>

The substrate 20 has a disk shape centered on the axis O. The substrate 20 is provided such that the outer peripheral surface 23 is coaxially fitted into the inner cylinder 13. The substrate 20 has an upstream end surface 21 and a downstream end surface 22.

### <Upstream End Surface>

The upstream end surface 21 is an end surface of the substrate 20, which faces the one side in the direction of the axis O, and has a planar shape orthogonal to the axis O. The upstream end surface 21 is disposed at the same position in the direction of the axis O as an end surface of the inner cylinder 13 on the one side in the direction of the axis O.

### <Downstream End Surface>

The downstream end surface 22 is an end surface of the substrate 20, which faces the other side in the direction of the axis O, and has a planar shape orthogonal to the axis O. The downstream end surface 22 is positioned on the one side in the direction of the axis O with respect to an end surface of the inner cylinder 13 on the other side in the direction of the axis O. Accordingly, a space is partitioned and formed by the inner peripheral surface of the inner cylinder 13 and the downstream end surface 22 of the substrate 20. The space is a combustion space of the combustor 3a.

### <Nozzle>

The substrate 20 is provided with a nozzle 30 that is a premixing pipe penetrating through the upstream end surface 21 and the downstream end surface 22. A plurality of nozzles 30 that are through-holes extending in the direction of the axis O are formed. An inside of the nozzle 30 is a flow path in which the one side in the direction of the axis O is an upstream side and the other side in the direction of the axis O is a downstream side. The air A circulates through the flow path from the upstream side toward the downstream side.

The nozzle 30 extends in a linear shape and has a uniform inner diameter in the direction of the axis O. The plurality of nozzles 30 are provided to be arranged at intervals in a direction orthogonal to the axis O.

Herein, a plenum (not shown) that is a space partitioned and formed to avoid the nozzle 30 is formed inside the substrate 20.

The fuel F is supplied into the plenum via a fuel supply pipe (not shown). Accordingly, an inside of the plenum is in a state of being filled with the fuel F. As the fuel F, hydrogen or a mixed fuel of the hydrogen and a natural gas is used.

A fuel jetting hole (not shown) for allowing the flow path in the nozzle 30 and the inside of the plenum to communicate with each other is formed in an inner peripheral surface of the nozzle 30. The fuel F filling the inside of the plenum is jetted into the nozzle 30 via the fuel jetting hole.

### <Temperature Detection Circuit>

As shown in FIG. 3, the temperature detection circuit 50 is a circuit (thermostat) for detecting a local temperature rise in each nozzle 30. The temperature detection circuit 50 is formed to extend in the direction orthogonal to the axis O and in the present embodiment, is formed in a planar shape to be laminated on a surface of the downstream end surface 22.

A plurality of temperature detection circuits 50 of the present embodiment are provided in parallel without interfering with each other. Each temperature detection circuit 50 extends in a meandering shape to pass around opening portions of the plurality of nozzles 30 while avoiding the nozzles 30.

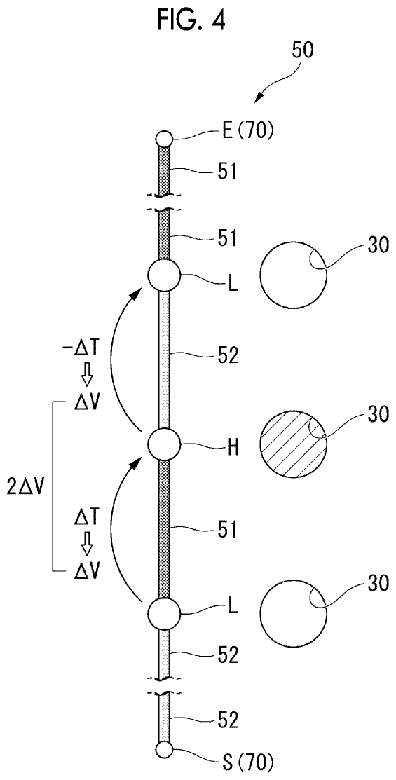

As shown in FIG. 4, the temperature detection circuit 50 extends in a single line from a starting point S to an end point E without branching. The starting point S and the end point E are output terminals 70 of the temperature detection circuit 50.

The temperature detection circuit 50 is formed by alternately connecting a plurality of positive element lines 51 and a plurality of negative element lines 52 from a starting point S side toward an end point E side. A connecting portion between the positive element line 51 and the negative element line 52 is a contact point. A plurality of contact points are provided according to the number of connecting portions between the positive element lines 51 and the negative element lines 52. The temperature detection circuit 50 is provided such that at least one contact point is present around each nozzle 30.

As materials for the positive element line 51 and the negative element line 52, a combination of different types of metals in which the Seebeck effect is exhibited can be appropriately adopted. Examples of the materials for the positive element line 51 and the negative element line 52 include chromel-alumel, iron-constantan, copper-constantan, chromel-constantan, and platinum-rhodium alloy-platinum. In these cases, the positive element line 51 functions as a positive leg, and the negative element line 52 functions as a negative leg.

Herein, as shown in detail in FIG. 4, a contact point formed by connecting the positive element line 51 and the negative element line 52 in this order from the starting point S side toward the end point E side of the temperature detection circuit 50 is a hot contact point H. In addition, a contact point formed by connecting the negative element line 52 and the positive element line 51 in this order from the starting point S side toward the end point E side of the temperature detection circuit 50 is a cold contact point L.

As shown in FIG. 4, when a local temperature rise occurs in one nozzle 30 of the plurality of nozzles 30, only the hot contact point H close to the nozzle 30 is heated.

Accordingly, a temperature gradient of ΔT occurs in the positive element line 51 between the heated hot contact point H and the cold contact point L adjacent thereto on the starting point S side, and as a result, an electromotive force of ΔV₊ is generated due to the Seebeck effect.

On the other hand, a temperature gradient of −ΔT occurs in the negative element line 52 between the heated hot contact point H and the cold contact point L adjacent thereto on the end point E side, and as a result, an electromotive force of ΔV₋ is generated due to the Seebeck effect.

For this reason, an electromotive force of ΔV is generated in the temperature detection circuit 50 as a whole.

In a case where a contact point close to the nozzle 30 where a local temperature rise has occurred is the cold contact point L, an electromotive force in a direction opposite to the above is generated.

That is, a temperature gradient of ΔT occurs in the negative element line 52 between the heated cold contact point L and the hot contact point H adjacent thereto on the starting point S side, and as a result, an electromotive force of −ΔV₊ is generated due to the Seebeck effect.

On the other hand, a temperature gradient of −ΔT occurs in the positive element line 51 between the heated cold contact point L and the hot contact point H adjacent thereto on the end point E side, and as a result, an electromotive force of −ΔV₋ is generated due to the Seebeck effect.

For this reason, an electromotive force of −ΔV is generated in the temperature detection circuit 50 as a whole.

Such a temperature detection circuit 50 is formed on the surface of the downstream end surface 22 by various wiring pattern formation methods such as vapor deposition, thermal spraying, and 3D printing. It is preferable that the temperature detection circuit 50 is formed by using a drawing device that directly draws on the surface of the downstream end surface 22. The drawing device that can continuously dispose a linear metal, for example, a welding robot or a 3D printer for a metal can be adopted. A welding device such as a laser metal deposition (LMD) device can also be adopted.

In addition, the temperature detection circuit 50 may be formed by directly laying the positive element line 51 and the negative element line 52 that are wires.

### <Combustor System>

In the present embodiment, calculation devices 100, 200, and 300 for detecting flashback of the combustor 3a are further provided. A combustor system 3 is configured by the combustor 3a and the calculation devices 100, 200, and 300.

### <Calculation Device>

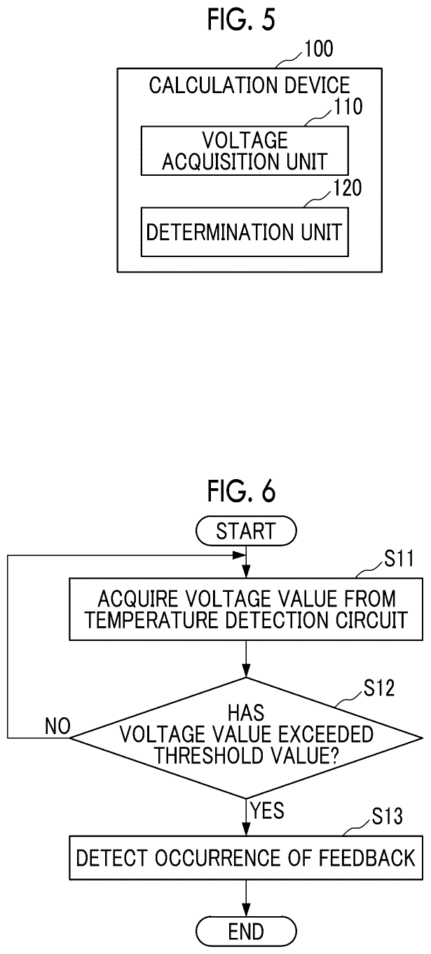

As shown in FIG. 5, the calculation device 100 has a voltage acquisition unit 110 and a determination unit 120.

The voltage acquisition unit 110 acquires a voltage value between the starting point S and the end point E that are the output terminals 70 in the temperature detection circuit 50 of the combustor 3a. In a case where there are the plurality of temperature detection circuits 50, the voltage acquisition unit 110 acquires a voltage value from each temperature detection circuit 50.

The determination unit 120 determines whether or not the voltage value acquired by the voltage acquisition unit 110 exceeds a threshold value determined in advance.

Next, a flow of processing of the calculation device 100 will be described with reference to a flowchart of FIG. 6.

In the calculation device 100, first, the voltage acquisition unit 110 acquires a voltage value from the temperature detection circuit 50 (step S11).

Next, the determination unit 120 determines whether or not the voltage value acquired by the voltage acquisition unit 110 exceeds the threshold value (step S12).

In a case where the voltage value does not exceed the threshold value, step S11 is executed again.

In a case where the voltage value exceeds the threshold value, it is detected that flashback has occurred (step S13).

### <Operational Effects>

Next, operations and operational effects of the gas turbine 1 according to the present embodiment will be described.

As shown in FIG. 2, during the operation of the gas turbine 1, the air A enters each nozzle 30 of the substrate 20 from the upstream side, and the air A circulates toward the downstream side inside the nozzle 30. As the fuel F is jetted into the air A in the nozzle 30, a premixed gas M is generated. The premixed gas M is jetted from the opening portion of the nozzle 30 in the downstream end surface 22 of the substrate 20 and is ignited. Accordingly, the combustion gas C is generated by combusting the premixed gas M, and the turbine 4 is rotationally driven by the combustion gas C being sent to the turbine 4.

Herein, depending on an operation state of the combustor 3a, flashback, which is a flame on the downstream side of the substrate 20 flowing back into the nozzle 30, occurs in some cases. In particular, in a case where the fuel F contains hydrogen, a flame propagation speed rises, and ignition energy greatly decreases, so that a risk of occurrence of flashback or abnormal combustion increases.

In the present embodiment, even in a case where such flashback occurs locally in some nozzles 30 of the plurality of nozzles 30, the flashback can be appropriately detected.

That is, in a case where flashback occurs in any one of the plurality of nozzles 30, only a temperature near the nozzle 30 abnormally rises compared to the surroundings. At that time, the temperature of the contact point (the hot contact point H or the cold contact point L) in the vicinity of the nozzle 30 rises rapidly. Due to the rapid change in temperature, a positive or a negative electromotive force is generated in the temperature detection circuit 50. By detecting this electromotive force from the output terminal 70 of the temperature detection circuit 50, it is possible to detect that flashback has occurred in any one of the nozzles 30.

Accordingly, for example, it is possible to avoid damage to the combustor 3a by fire by appropriately regulating a supply amount of the fuel F, and an appropriate combustion condition can be set by fuel control.

Herein, in a case where a contact point of a thermocouple is provided in each of the plurality of nozzles 30, it is necessary to provide a positive leg element line and a negative leg element line for each contact point, which leads to complication and elongation of a circuit length. On the other hand, in the present embodiment, the plurality of contact points are formed by alternately connecting the positive element line 51 and the negative element line 52. Therefore, the contact point can be provided around each nozzle 30 due to a single line circuit. Therefore, it is possible to detect occurrence of flashback with a simple configuration.

In addition, since at least one contact point is disposed around each nozzle 30, a local abnormal temperature rise for each nozzle 30 can be detected. For this reason, occurrence of flashback can be appropriately detected.

Further, since the temperature detection circuit 50 is disposed on the downstream end surface 22, each contact point can directly receive a flame of flashback without passing through a heat transfer layer. For this reason, occurrence of flashback can be detected without delay.

There is a case where temperature rise detection by the temperature detection circuit 50 is excessively sensitive, and unevenness of a surface temperature of the downstream end surface 22 is mistakenly detected as flashback. In order to avoid such a case, a thermal insulation coating layer may be thinly provided on a surface of the contact point. The thermal insulation coating layer can be formed, for example, by performing thermal insulation treatment on the contact point. Accordingly, sensitivity regulation can be performed so that the abnormal temperature is detected only when a flame flashes back. As a result, misdetection can be suppressed.

In addition, in the present embodiment, since the plurality of temperature detection circuits 50 are provided, a region where flashback has occurred can be identified to some extent by detecting voltage values thereof.

### Second Embodiment

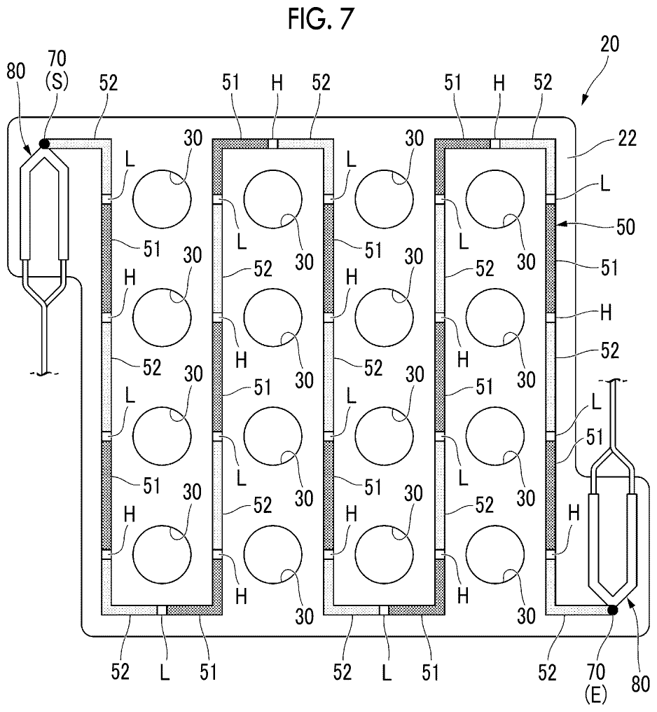

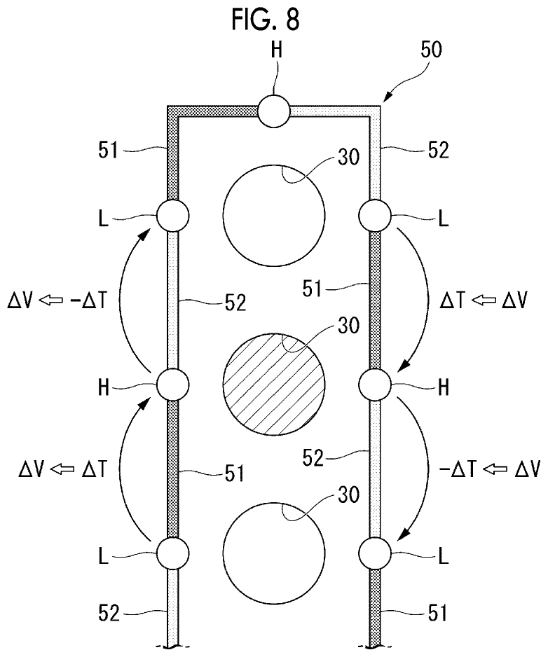

Next, a second embodiment of the present invention will be described in detail with reference to FIGS. 7 and 8. In the present embodiment, the same reference signs will be assigned to components which are the same as those according to the first embodiment, and detailed description thereof will be omitted.

In the combustor 3a of the second embodiment, the plurality of nozzles 30 are regularly disposed in a grid pattern on the downstream end surface 22 of the substrate 20. In the present embodiment, a total of 16 nozzles 30 are disposed in a matrix shape, that is, in a square shape as a whole, in four vertical lines and four horizontal lines (four rows and four columns).

The temperature detection circuit 50 is spread along the downstream end surface 22 to meander around such a plurality of nozzles 30. The starting point S and the end point E that are the output terminals 70 of the temperature detection circuit 50 are disposed at corner portions diagonally opposite to each other in a square shape. The temperature detection circuit 50 extends to pass around all the nozzles 30 from the starting point S to the end point E while meandering to proceed in a lateral direction while being folded back for each vertical line. The temperature detection circuit 50 extends from the starting point S to the end point E in a single line without branching in the middle.

At the end point E and the starting point S, which are output points of the temperature detection circuit 50, reference thermocouples 80 for calibrating a deviation from a reference temperature by detecting temperatures of the points are provided.

Herein, in the temperature detection circuit 50 of the present embodiment, contact points are provided so that each nozzle 30 is interposed therebetween. A pair of contact points are disposed to face each other so that one nozzle 30 is interposed therebetween from both sides in the lateral direction (right and left in FIG. 7). The contact points disposed to face each other are either the hot contact points H or the cold contact points L, that is, attributes (attributes of the hot contact point H or the cold contact point L) of the pair of contact points between which the one nozzle 30 is interposed are the same.

For example, as shown in FIG. 8, in a case where the temperature of the center nozzle 30, among the three vertically arranged nozzles 30, rises, as described in the first embodiment, an electromotive force of ΔV is generated before and after each of the hot contact points H between which the center nozzle 30 is interposed. Accordingly, a total electromotive force of 2ΔV is generated at the temperature detection circuit 50. Flashback is detected as in the first embodiment based on the electromotive force.

In addition, in a case where the pair of contact points between which the nozzle 30, of which a temperature has risen, is interposed are the cold contact points L, an electromotive force of −ΔV is generated before and after of the cold contact points L. Accordingly, a total electromotive force of −2ΔV is generated at the temperature detection circuit 50. Flashback is detected as in the first embodiment based on the electromotive force.

### <Operational Effects>

In the present embodiment, the temperature detection circuit is provided in a single line to pass through the vicinity of all the nozzles 30. For this reason, as in the first embodiment, it is possible to detect flashback with a simple configuration while avoiding complication or elongation of the circuit length.

Herein, in a case where the pair of contact points disposed so that the nozzle 30 is interposed therebetween is a combination of the hot contact point H and the cold contact point L, due to a temperature rise of the nozzle 30, a negative electromotive force is generated at the cold contact point L while a positive electromotive force is generated at the hot contact point H. In this case, in the single-line temperature detection circuit, the positive and negative electromotive forces cancel each other, and a voltage value output from the output terminal 70 becomes small or 0.

On the other hand, in the present embodiment, since the attributes of the pair of contact points between which one nozzle 30 is interposed are the same, the generated electromotive forces are not canceled out. For this reason, flashback can be appropriately detected.

In addition, since the polarities of voltage values generated from the contact points between which one nozzle 30 is interposed are the same, a double voltage value can be detected. Accordingly, flashback can be detected at a stage where the temperature rise is smaller, and flashback can be detected at an early stage.

In addition, in the present embodiment, among the total of 16 nozzles 30 arranged in four rows and four columns, the nozzles 30 in the first and third rows are interposed between the cold contact points L, and the nozzles 30 in the second and fourth rows are interposed between the hot contact points H. For this reason, whether flashback has occurred and the nozzle 30 is positioned in an odd row or an even row can be determined depending on the polarity of the generated electromotive force.

### Third Embodiment

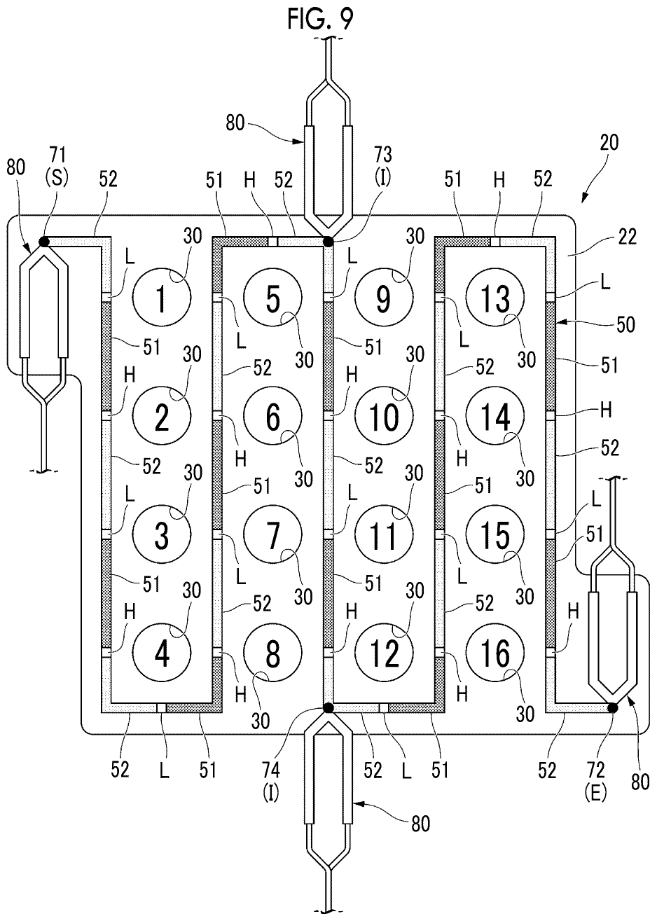

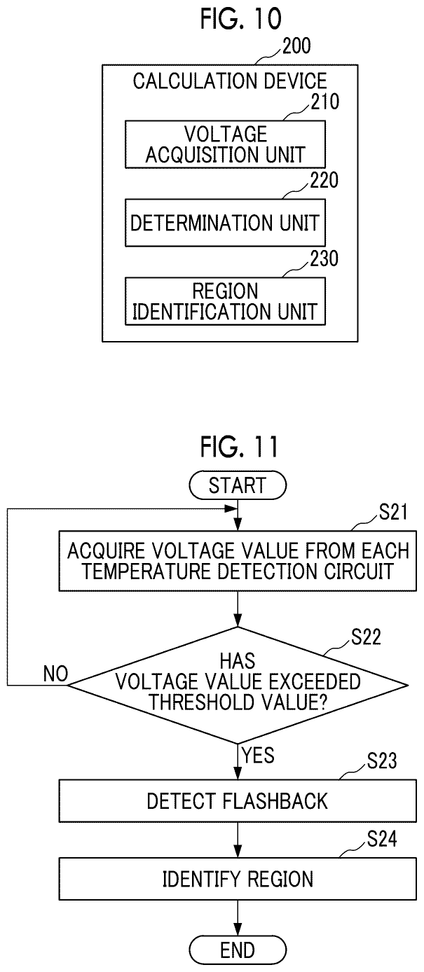

Next, a third embodiment of the present invention will be described with reference to FIGS. 9 to 11. In the present embodiment, the same reference signs will be assigned to components which are the same as those according to the other embodiments, and detailed description thereof will be omitted.

The substrate 20 of the third embodiment has the same configuration as that of the second embodiment. Herein, the 16 nozzles 30 are defined as No. 1 nozzle 30 to No. 16 nozzle 30 as shown in FIG. 9.

In addition, in the temperature detection circuit 50 of the third embodiment, in addition to the starting point S and the end point E, two intermediate points I between the starting point S and the end point E are further defined as output terminals.

That is, the two intermediate points I are provided at middle positions of the temperature detection circuit to be separated from each other. One intermediate point I is provided on the temperature detection circuit 50 between the No. 5 nozzle 30 and the No. 9 nozzle 30. The other intermediate point I is provided on the temperature detection circuit 50 between the No. 8 nozzle 30 and the No. 12 nozzle 30.

In the present embodiment, the starting point S is defined as a first output terminal 71, the end point E is defined as a second output terminal 72, the one intermediate point I is defined as a third output terminal 73, and the other intermediate point I is defined as a fourth output terminal 74. The reference thermocouples 80 are also provided at the third output terminal 73 and the fourth output terminal 74, as in the first output terminal 71 and the second output terminal 72.

Next, the calculation device 200 of the third embodiment, which constitutes the combustor system 3 together with the combustor 3a, will be described.

The calculation device 200 of the third embodiment has a voltage acquisition unit 210, a determination unit 220, and a region identification unit 230.

The voltage acquisition unit 210 acquires a voltage value between a plurality of output terminals. In the present embodiment, a total of five voltage values including
(1) a voltage value between the first output terminal 71 and the second output terminal 72,
(2) a voltage value between the first output terminal 71 and the third output terminal 73,
(3) a voltage value between the first output terminal 71 and the fourth output terminal 74,
(4) a voltage value between the second output terminal 72 and the third output terminal 73, and
(5) a voltage value between the second output terminal 72 and the fourth output terminal 74 are acquired.

The determination unit 220 determines whether or not the voltage values of (1) to (5) above exceed a threshold value determined in advance.

The region identification unit 230 identifies in which region between the plurality of output terminals flashback has occurred from a voltage value exceeding the threshold value, among the voltage values of (1) to (5).

Next, a flow of processing of the calculation device 200 will be described with reference to a flowchart of FIG. 11.

First, the voltage acquisition unit 210 acquires voltage values between all the output terminals of (1) to (5) above (step S21).

Next, the determination unit 220 determines whether or not the voltage values between the output terminals of (1) to (5) exceed the threshold value (step S22). In a case where none of the voltage values between the output terminals exceeds the threshold value, the determination unit 220 executes step S21 again. In addition, the determination unit 220 detects that flashback has occurred in a case where any voltage value between the output terminals exceeds the threshold value (step S23).

After then, a region where the flashback has occurred is identified based on information between the output terminals in which the voltage value exceeds the threshold value (step S24). The region identification unit 230 identifies the region according to, for example, a table shown in Table 1 stored in advance.

TABLE 1

Voltage value between output terminals

| Nozzle No. | 1-2 | 1-3 | 1-4 | 2-3 | 2-4 |
|---|---|---|---|---|---|
| 1 | + | + | + | 0 | 0 |
| 2 | − | − | − | 0 | 0 |
| 3 | + | + | + | 0 | 0 |
| 4 | − | − | − | 0 | 0 |
| 5 | + | + | + | + | 0 |
| 6 | − | − | − | − | 0 |
| 7 | + | + | + | + | 0 |
| 8 | − | − | − | − | 0 |
| 9 | + | 0 | + | + | + |
| 10 | − | 0 | − | − | − |
| 11 | + | 0 | + | + | + |
| 12 | − | 0 | − | − | − |
| 13 | + | 0 | 0 | + | + |
| 14 | − | 0 | 0 | − | − |
| 15 | + | 0 | 0 | + | + |
| 16 | − | 0 | 0 | − | − |

In Table 1,
“1-2” indicates (1) the above voltage value between the first output terminal 71 and the second output terminal 72,
“1-3” indicates (2) the above voltage value between the first output terminal 71 and the third output terminal 73,
“1-4” indicates (3) the above voltage value between the first output terminal 71 and the fourth output terminal 74,
“2-3” indicates (4) the above voltage value between the second output terminal 72 and the third output terminal 73, and
“2-4” indicates (5) the above voltage value between the second output terminal 72 and the fourth output terminal 74.

In addition, “+” indicates “a + voltage value exceeds the threshold value”, and “−” indicates “a − voltage value exceeds the threshold value”. “O” indicates that the voltage value is not detected or that the detected voltage value does not exceed the threshold value.

According to Table 1, for example, in a case where “1-2” is +, “1-3” is +, “1-4” is +, “2-3” is 0, and “2-4” is 0, it can be determined that flashback has occurred in any of the No. 1 and No. 3 nozzles 30.

In addition, for example, in a case where “1-2” is −, “1-3” is −, “1-4” is −, “2-3” is −, and “2-4” is 0, it can be determined that flashback has occurred in any one of the No. 6 and No. 8 nozzles 30.

Further, according to Table 1, for example, in a case where “1-2” is −, “1-3” is 0, “1-4” is 0, “2-3” is −, and “2-4” is −, it can be determined that flashback has occurred in any of the No. 14 and No. 16 nozzles 30.

As described above, according to the present embodiment, a region where flashback has occurred can be identified based on a voltage value between the plurality of output terminals. Accordingly, for example, the flow rate of a fuel supplied to the nozzle 30 in the region where the flashback has occurred can be decreased, and damage to the nozzle 30 by fire can be avoided. In addition, in this case, by increasing the flow rate of the fuel supplied to the nozzle 30 in a region where flashback has not occurred, a decrease in an overall output of the combustor 3a can be suppressed.

### Fourth Embodiment

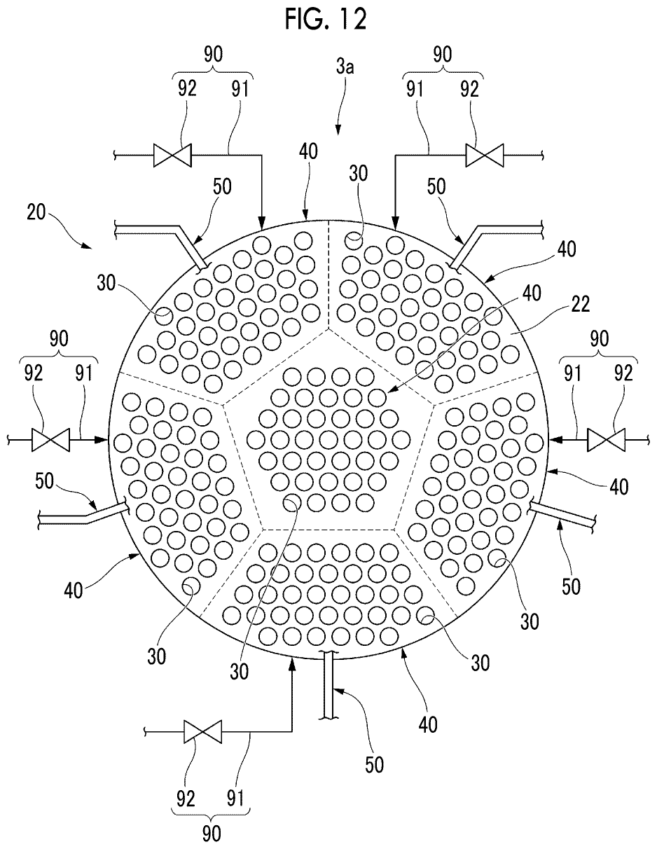

Next, a fourth embodiment of the present invention will be described with reference to FIGS. 12 to 14. In the present embodiment, the same reference signs will be assigned to components which are the same as those according to the other embodiments, and detailed description thereof will be omitted.

As shown in FIG. 12, in the present embodiment, a nozzle segment 40 is configured by the plurality of nozzles 30 being collectively disposed. One nozzle segment 40 is disposed at the center, and a plurality of nozzle segments 40 (five in the present embodiment) are disposed on an outer peripheral side to surround the nozzle segment 40 at the center.

A plurality of plenums partitioned and formed in the substrate 20 are formed to be independent for each nozzle segment 40. That is, the plurality of (six in the present embodiment) plenums separated from each other are formed in the substrate 20, and the plenums and each nozzle segment 40 are in a corresponding relationship of with each other. The fuel F filling the corresponding plenum is supplied to the nozzle 30 of each nozzle segment 40.

Accordingly, in the present embodiment, a fuel supply unit 90 is provided for each of the plurality of plenums. The fuel supply unit 90 has a fuel supply line 91 that is connected to each plenum and a regulating valve 92 that is provided in the fuel supply line 91.

The fuel supply line 91 is connected to a fuel supply source (not shown). The fuel F is supplied to each of the plenums via the fuel supply line 91.

The regulating valve 92 is provided in each fuel supply line 91. The flow rate of the fuel F that passes through each fuel supply line 91 is regulated by the regulating valve 92, so that the flow rate of the fuel F supplied to each plenum is determined. The fuel F from the fuel supply unit 90, which corresponds to a supply amount, is ejected into the nozzle 30 from each plenum. That is, the fuel supply unit 90 regulates the flow rate of the fuel F supplied to the nozzle 30 for each nozzle segment 40.

In the present embodiment, the temperature detection circuit 50 is provided to correspond to each nozzle segment 40. The temperature detection circuit 50 corresponding to the nozzle segment 40 is spread over an installation range of the nozzle segment 40 on the downstream end surface 22 to pass around each of the nozzles 30 of the nozzle segment 40.

The calculation device 300 is provided in the combustor 3a of the present embodiment, and accordingly, the combustor system 3 is configured by the calculation device 300.

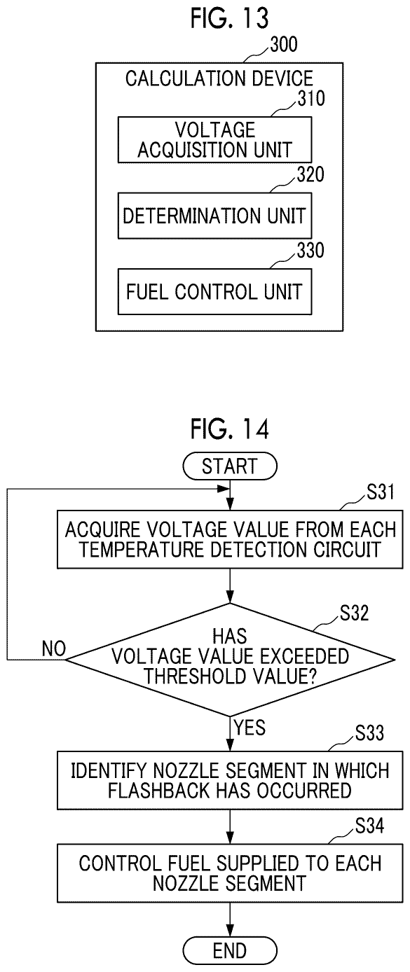

As shown in FIG. 13, the calculation device 300 has a voltage acquisition unit 310, a determination unit 320, and a fuel control unit 330.

The voltage acquisition unit 310 detects a voltage value output from the temperature detection circuit 50 for each of the plurality of nozzle segments 40.

The determination unit 320 determines whether or not a voltage value of the temperature detection circuit 50 corresponding to each nozzle segment 40 exceeds the threshold value determined in advance.

The fuel control unit 330 controls the amount of fuel supplied to the plenum corresponding to each nozzle segment 40 according to the determination result of the determination unit 320.

Next, a flow of processing of the calculation device 300 will be described with reference to a flowchart of FIG. 14.

First, the voltage acquisition unit 310 acquires a voltage value for each temperature detection circuit 50 corresponding to each nozzle segment 40 (step S31).

Next, the determination unit 320 determines whether or not each acquired voltage value corresponding to each nozzle segment 40 exceeds the threshold value determined in advance (step S32). In a case where the voltage value does not exceed the threshold value, step S31 is executed again.

Then, in a case where the determination unit 320 determines that the identified voltage value exceeds the threshold value, it is detected that flashback has occurred in the nozzle segment 40 corresponding to the voltage value. That is, the nozzle segment 40 in which the flashback has occurred is identified (step S33).

After then, the fuel control unit 330 controls the amount of the fuel F supplied to each nozzle segment 40 (step S34). That is, control of decreasing the amount of fuel supplied to the nozzle segment 40 identified that flashback has occurred is performed. Specifically, control of decreasing the flow rate with respect to the regulating valve 92 of the fuel supply unit 90 that supplies the fuel F to the nozzle segment 40 is performed.

At the same time, control of increasing the amount of fuel supplied to the plurality of nozzle segments 40 other than the nozzle segment 40 identified that flashback has occurred is performed. Specifically, control of increasing the flow rate with respect to the regulating valve 92 of the fuel supply unit 90 that supplies the fuel F to the nozzle segments 40 is performed. In this case, the fuel supply amount is controlled by each regulating valve 92 so that the total fuel supply amount of the nozzle segments 40 does not change before and after the control.

### <Operational Effects>

According to the present embodiment, as the temperature detection circuit 50 is provided for each of the plurality of nozzle segments 40, in which segment, among the plurality of nozzle segments 40, flashback has occurred can be appropriately detected.

In addition, the fuel control unit 330 decreases the amount of fuel supplied to the nozzle segment 40 in which flashback has occurred, so that damage to the nozzle segment 40 by fire can be avoided. In addition, supply of the fuel F to the nozzle segments 40 other than the nozzle segment 40 can be continued, so that the operation of the combustor 3a can be continued.

Further, by increasing the amount of fuel supplied to the nozzle segments 40 in which flashback has not occurred, an overall output of the combustor 3a can be maintained.

### Fifth Embodiment

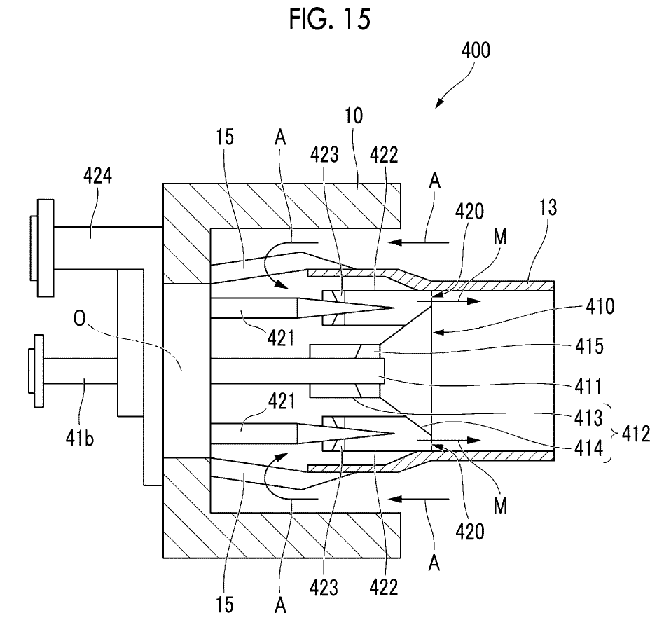

Next, a fifth embodiment of the present invention will be described with reference to FIGS. 15 to 18. In the present embodiment, the same reference signs will be assigned to components which are the same as those according to the other embodiments, and detailed description thereof will be omitted.

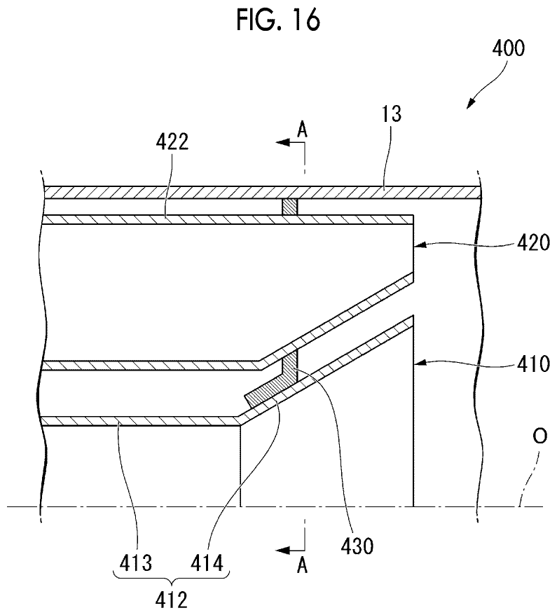

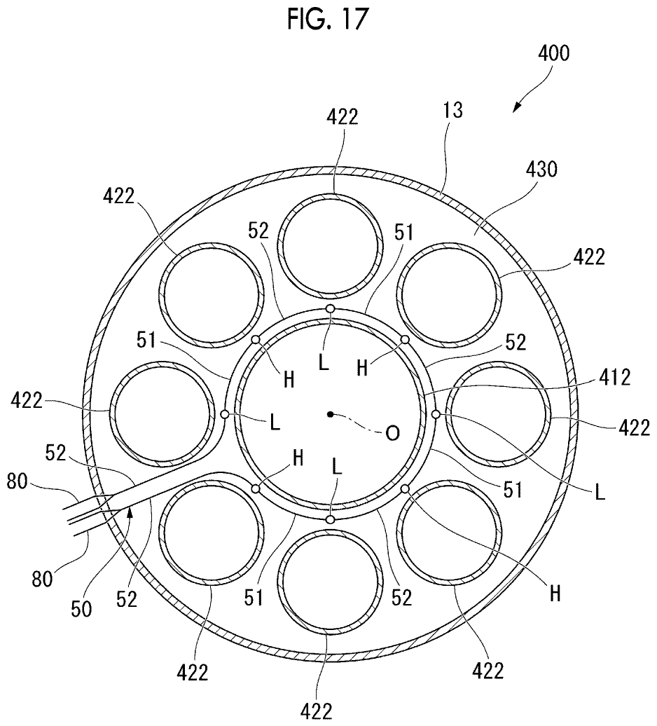

As shown in FIG. 12, a combustor 400 of the fifth embodiment has a different overall configuration from those of the other embodiments. The combustor 400 of the fifth embodiment includes the outer cylinder 10, the inner cylinder 13, the support unit 15, a pilot burner 410, a main burner 420, and a substrate 430 (see FIGS. 16 and 17).

The pilot burner 410 is provided inside the outer cylinder 10 and the inner cylinder 13. The pilot burner 410 has a pilot nozzle 411, a pilot burner cylinder 412, and a pilot swirler 415. The pilot nozzle 411 extends along the axis O.

A base end portion of the pilot nozzle 411 is connected to a pilot fuel port 416.

The pilot burner cylinder 412 is provided inside the inner cylinder 13 to surround the pilot nozzle 411 from the surroundings. The pilot burner cylinder 412 has a cylindrical portion 413 that has a cylindrical shape extending along the axis O and a pilot cone 414 that has a tubular shape which is connected to a tip side of the pilot nozzle 411 in the cylindrical portion 413 and which has a diameter increasing toward the tip side.

The pilot swirler 415 is provided between the pilot nozzle 411 and the cylindrical portion 413 of the pilot burner cylinder 412.

Inside the outer cylinder 10 and the inner cylinder 13, a plurality of main burners 420 are provided in the circumferential direction to surround the pilot nozzle 411 from the outer peripheral side. The main burner 420 has a main nozzle 421, a main burner cylinder 422 that is a premixing pipe, and a main swirler 423.

A base end portion of the main nozzle 421 is connected to a main fuel port 424, and the fuel F is introduced into the main nozzle 421 via the main fuel port 424.

The main burner cylinder 422 has a cylindrical shape extending along the axis O and surrounds the main nozzle 421 from the outer peripheral side. As shown in FIG. 16, the tip side of the main burner cylinder 422 gradually decreases in diameter toward the tip side according to the shape of the pilot cone 414. Each main burner cylinder 422 and the pilot burner cylinder 412 are disposed to be separated from each other via a gap therebetween. Each main burner cylinder 422 is disposed to be separated from the inner cylinder 13 via a gap.

The main swirler 423 is provided between the main nozzle 421 and the main burner cylinder 422.

### <Substrate>

As shown in FIGS. 16 and 17, the substrate 430 is disposed inside the inner cylinder 13 and has a disk shape extending in the direction orthogonal to the axis O. The outer peripheral surface 23 of the substrate 430 is fixed to the inner peripheral surface of the inner cylinder 13 over the entire circumference. The substrate 430 supports the pilot burner 410 and the main burner 420 inside the inner cylinder 13. The pilot burner 410 and the main burner 420 are disposed to penetrate the substrate 430, respectively. That is, a plurality of through-holes are formed in the substrate 430, and the pilot cone 414 of the pilot burner 410 and the main burner cylinder 422 of the main burner 420 are supported via the through-holes.

### <Temperature Detection Circuit>

Herein, as shown in FIG. 17, the temperature detection circuit 50 is provided on the substrate 430. In the present embodiment, the temperature detection circuit 50 is formed in a planar shape to be laminated on a surface of the substrate 430, which faces the downstream side. The temperature detection circuit 50 may be laminated on a surface of the substrate 430, which faces the upstream side, or may be configured to be embedded in the substrate 430.

The temperature detection circuit 50 is disposed between the pilot cone 414 and each main burner cylinder 422 to extend in the circumferential direction. Each contact point of the temperature detection circuit 50 is provided between the pilot cone 414 and each main burner cylinder 422. That is, the respective contact points are arranged such that the hot contact point H and the cold contact point L alternately exist in the circumferential direction on the outer peripheral side of the pilot cone 414.

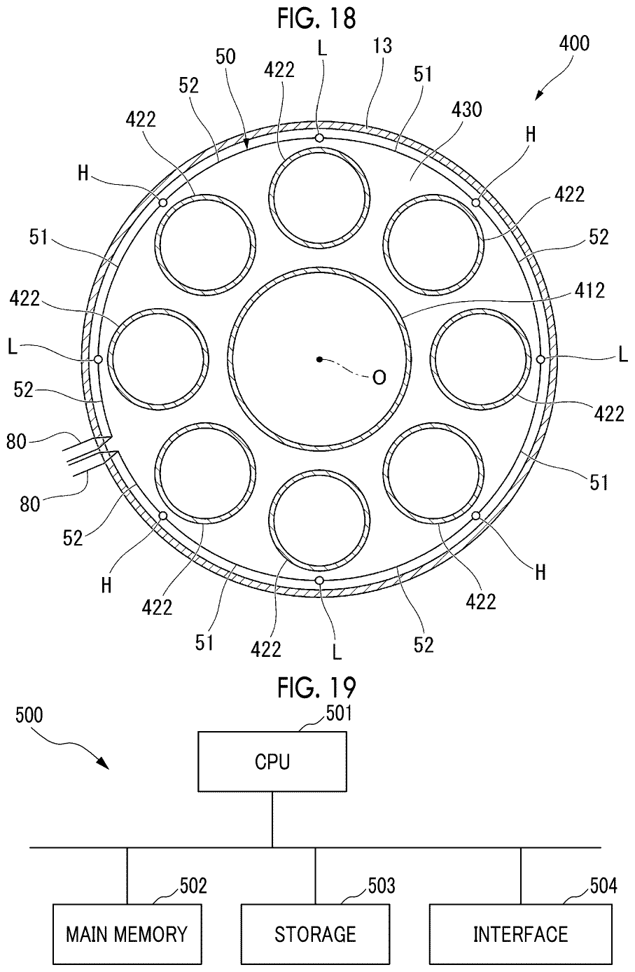

As a modification example of the fifth embodiment, for example, as shown in FIG. 18, the temperature detection circuit 50 may be provided to surround the main burner cylinder 422, that is, in the modification example, the temperature detection circuit 50 is provided to extend in the circumferential direction between the plurality of main burner cylinders 422 and the inner cylinder 13. Each contact point is provided between each main burner cylinder 422 and the inner cylinder 13 to correspond to each main burner cylinder 422.

### <Operational Effects>

Also in the fifth embodiment, as in other embodiments, even in a case where flashback has occurred locally in some of the main burner cylinders 422 among the plurality of main burners 420, the flashback can be appropriately detected.

### OTHER EMBODIMENTS

Although the embodiments of the present invention have been described hereinbefore, the present invention is not limited thereto and can undergo some changes as appropriate without departing from the technical spirit of the invention.

In the embodiment, the plenum is provided in the substrate 20, and the fuel F is supplied from the plenum into each nozzle 30. However, the present invention is not limited thereto. For example, a configuration where a fuel supply nozzle is inserted into each nozzle 30 from the upstream side, and the fuel F is supplied into the nozzle 30 by the fuel supply nozzle may be adopted.

In addition, at least one contact point corresponding to each nozzle 30 is provided around the nozzle 30 in the embodiment. However, the contact point may not be provided around all the nozzles 30. For example, a configuration where one contact point is provided for each of the plurality of nozzles 30 may be adopted. In addition, in an extending direction of the temperature detection circuit 50, the contact point may be provided while skipping one or the plurality of nozzles 30.

On the other hand, a plurality of contact points may be provided to correspond to the nozzles 30, respectively.

In the second and third embodiments, a structure in which the nozzles 30 are disposed in four vertical lines and four horizontal lines (four rows and four columns) has been described. However, the present invention is not limited thereto. That is, the nozzles 30 may be arranged in a matrix shape in a plurality of vertical lines and a plurality of horizontal lines or may be arranged in another arrangement such as staggered arrangement.

In the embodiment, a configuration where the temperature detection circuit 50 is formed on the downstream end surface 22 of the substrate 20 has been described. However, the present invention is not limited thereto. A configuration where the temperature detection circuit 50 is embedded in the substrate 20 may be adopted.

In addition, when a temperature response is excessively fast in a case where the temperature detection circuit 50 is formed on the downstream end surface 22, it is difficult to determine between flashback and other events such as noise and combustion vibration. Therefore, the temperature response may be delayed by shallowly embedding the temperature detection circuit 50 from the downstream end surface 22 or providing a thin heat insulating layer on the temperature detection circuit 50.

The calculation devices 100, 200, and 300 of other embodiments may be provided in the fifth embodiment.

Processes of processing performed by the calculation devices 100, 200, and 300 described above are stored in a recording medium readable by a computer 500 in the form of a program, and the above processes are performed by the computer 500 reading and executing the program. A specific example of the computer 500 will be described below.

As shown in FIG. 19, the computer 500 includes a CPU 501, a main memory 502, a storage 503, and an interface 504.

For example, the calculation devices 100, 200, and 300 described above are mounted on the computer 500. An operation of each of the processing units described above is stored in the form of the program in the storage 503. The CPU 501 reads the program from the storage 503, develops the program in the main memory 502, and executes the above processing according to the program. In addition, the CPU 501 secures a storage area in the main memory 502 according to the program.

Examples of the storage 503 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 503 may be an internal medium directly connected to a bus of the computer 500 or may be an external medium connected to the computer 500 via the interface 504 or a communication line. In addition, in a case where the program is distributed to the computer 500 by the communication line, the computer 500 that has received the distribution may develop the program in the main memory 502 and execute the processing. The storage 503 is a non-temporary tangible storage medium.

In addition, the program may realize some of the functions described above. Further, the program may be a file that can realize the functions described above in combination with a program already recorded in the computer 500, that is, a so-called differential file (differential program).

In addition to the above configuration or instead of the above configuration, a custom large scale integrated circuit (LSI), such as a programmable logic device (PLD), an application specific integrated circuit (ASIC), a graphics processing unit (GPU), and a processing device similar thereto may be provided. Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

### Appendix

The combustors 3a and 400, the combustor system 3, and the gas turbine 1 described in each of the embodiments are understood as follows, for example.
(1) The combustor 3a and 400 according to a first aspect includes the substrates 20 and 430 that extend in the direction orthogonal to the axis O, the plurality of premixing pipes 30 and 422 that extend to penetrate the substrates 20 and 430 and that jet the premixed gas M generated by mixing the fuel F with the air A introduced from the upstream side from the opening portions on the downstream side, and the temperature detection circuit 50 that is provided on the substrates 20 and 430 and that extends in the direction orthogonal to the axis O to pass around each of the premixing pipes 30 and 422, and the temperature detection circuit 50 has the starting point S and the end point E that are the output terminals 70 of the temperature detection circuit 50 and the plurality of contact points formed by alternately connecting the plurality of positive element lines 51 and the plurality of negative element lines 52 from the starting point S side toward the end point E side.

According to the above configuration, when flashback occurs in any one of the plurality of premixing pipes 30 and 422 and the temperatures of the premixing pipes 30 and 422 rise, the temperatures of the contact points in the vicinity of the premixing pipes 30 and 422 rise. Accordingly, an electromotive force is generated in the temperature detection circuit 50. By detecting this electromotive force from the output terminal 70 of the temperature detection circuit 50, it can be detected that flashback has occurred in any of the premixing pipes 30 and 422.
(2) The combustors 3a and 400 according to a second aspect are the combustor 3a according to the first aspect, in which at least one of the contact points is disposed around each of the premixing pipes 30 and 422.

Accordingly, an abnormal temperature rise can be detected in each of the premixing pipes 30 and 422, and occurrence of flashback can be detected.
(3) The combustors 3a and 400 according to a third aspect are the combustors 3a and 400 according to the first or second aspect, in which the temperature detection circuit 50 is formed on the surfaces of the substrates 20 and 430, which face the downstream side.

Accordingly, when flashback occurs, a temperature rise can be directly detected by the contact point without passing through another heat transfer layer.
(4) The combustors 3a and 400 according to a fourth aspect are the combustors 3a and 400 according to the third aspect, in which the temperature detection circuit 50 has the thermal insulation coating layer formed on the surface of the temperature detection circuit 50.

Accordingly, sensitivity regulation can be performed so that an abnormal temperature is detected only when a flame flashes back.
(5) The combustors 3a and 400 according to a fifth aspect are the combustor 3a according to any one of the first to fourth aspects, in which the contact point includes the hot contact point H that is formed by connecting the positive element lines 51 and the negative element lines 52 in this order from the starting point S side toward the end point E side of the temperature detection circuit 50 and the cold contact point L that is formed by connecting the negative element lines 52 and the positive element lines 51 in this order from the starting point S side toward the end point E side of the temperature detection circuit 50, the pair of contact points are disposed to face each other so that the premixing pipes 30 and 422 are interposed therebetween, and the pair of contact points are either the hot contact points H or the cold contact points L.

Herein, a positive electromotive force is generated at the hot contact point H due to a temperature rise, and a negative electromotive force is generated at the cold contact point L due to the temperature rise. For this reason, for example, in a case where the hot contact point H and the cold contact point L are disposed to face each other with the identified premixing pipes 30 and 422 interposed therebetween, electromotive forces generated at the hot contact point H and the cold contact point L due to the temperature rises of the premixing pipes 30 and 422 cancel each other out. On the other hand, in the present aspect, the pair of hot contact points H or the pair of cold contact points L are disposed to face each other with the premixing pipes 30 and 422 interposed therebetween. Therefore, the electromotive forces are not canceled out with each other. Therefore, an abnormal temperature rise can be appropriately detected.
(6) The combustors 3a and 400 according to a sixth aspect are the combustor 3a according to any one of the first to fifth aspects, in which the temperature detection circuit 50 has the intermediate point I that is the output terminal 70 between the starting point S and the end point E.

By detecting an electromotive force between the starting point S and the intermediate point I, an electromotive force between the intermediate point I and the end point E, and an electromotive force between the intermediate point I and the intermediate point I as well as a voltage value between the starting point S and the end point E, in which region flashback has occurred can be detected.
(7) The combustors 3a and 400 according to a seventh aspect are the combustor 3a according to any one of the first to sixth aspects, in which the substrate 20 has the plurality of nozzle segments 40, in which the plurality of premixing pipes 30 and 422 are collectively disposed, and the temperature detection circuit 50 is provided for each of the plurality of nozzle segments 40.

Accordingly, whether or not flashback has occurred can be detected for each of the nozzle segments 40.
(8) The combustor system 3 according to an eighth aspect includes the combustors 3a and 400 according to any one of the first to fifth aspects and the calculation device 100 that detects flashback based on a voltage value output from the output terminal 70.

Flashback can be detected with high accuracy by using a voltage value acquired from a temperature abnormality circuit.
(9) The combustor system 3 according to a ninth aspect includes the combustors 3a and 400 according to the sixth aspect and the calculation device 200 that calculates detection of in which region between the plurality of output terminals 70 flashback has occurred based on a voltage value output from each of the plurality of output terminals 70.

By acquiring a voltage value between the plurality of output terminals 70, in which region between the output terminals 70 flashback has occurred can be detected with high accuracy.
(10) The combustor system 3 according to a tenth aspect includes the combustors 3a and 400 according to the seventh aspect and the calculation device 300 that identifies the nozzle segments 40 in which flashback has occurred based on a voltage value output from the output terminal 70 of each temperature detection circuit 50.

Accordingly, in which segment flashback has occurred, among the plurality of nozzle segments 40, can be appropriately detected.
(11) The combustor system 3 according to an eleventh aspect is the combustor system 3 according to the tenth aspect further includes the fuel supply unit 90 that can regulate the amount of the fuel F supplied to each of the nozzle segments 40, and the calculation device 300 decreases the amount of the fuel F supplied to the nozzle segments 40 identified that flashback has occurred and increases the amount of the fuel F supplied to the other nozzle segments 40.

Accordingly, overall outputs of the combustors 3a and 400 can be maintained while suppressing damage to the nozzle segments 40 by fire in which flashback has occurred.
(12) The gas turbine 1 according to a twelfth aspect includes the combustor system 3 according to any one of the eighth to tenth aspects, into which the air A is introduced to generate the combustion gas C, the compressor 2 that supplies the compressed air A to the combustor system 3, and the turbine 4 that is driven by the combustion gas C.

### REFERENCE SIGNS LIST

1 gas turbine
2 compressor
3 combustor system
3a combustor
4 turbine
10 outer cylinder
11 end cover
13 inner cylinder
15 support unit
20 substrate
21 upstream end surface
22 downstream end surface
23 outer peripheral surface
30 nozzle (premixing pipe)
40 nozzle segment
50 temperature detection circuit
51 positive element line
52 negative element line
70 output terminal
71 first output terminal
72 second output terminal
73 third output terminal
74 fourth output terminal
80 reference thermocouple
90 fuel supply unit
91 fuel supply line
92 regulating valve
100 calculation device
110 voltage acquisition unit
120 determination unit
200 calculation device
210 voltage acquisition unit
220 determination unit
230 region identification unit
300 calculation device
310 voltage acquisition unit
320 determination unit
330 fuel control unit
400 combustor
410 pilot burner
411 pilot nozzle
412 pilot burner cylinder
413 cylindrical portion
414 pilot cone
415 pilot swirler
416 pilot fuel port
420 main burner
421 main nozzle
422 main burner cylinder (premixing pipe)
423 main swirler
424 main fuel port
430 substrate
500 computer
501 CPU
502 main memory
503 storage
504 interface
O axis
A air
F fuel
M premixed gas
C combustion gas
S starting point
E end point
I intermediate point
H hot contact point
L cold contact point

1. A combustor comprising:
a substrate that extends in a direction orthogonal to a combustor axis;
a plurality of premixing pipes that extend to penetrate the substrate and that jet a premixed gas generated by mixing a fuel with air, which is introduced from an upstream side, from an opening portion on a downstream side; and
a temperature detection circuit that is provided on the substrate and that extends in the direction orthogonal to the combustor axis to pass around each of the premixing pipes, wherein
the temperature detection circuit has a starting point and an end point that are output terminals of the temperature detection circuit and has a plurality of contact points formed by alternately connecting a plurality of positive element lines and a plurality of negative element lines from a starting point side toward an end point side, and
the temperature detection circuit has an intermediate point that is an output terminal between the starting point and the end point.

2. The combustor according to claim 1, wherein at least one of the contact points is disposed around each of the premixing pipes.

3. The combustor according to claim 1, wherein the temperature detection circuit is formed along a surface of the substrate, which faces the downstream side.

4. The combustor according to claim 3, wherein the temperature detection circuit has a thermal insulation coating layer that is formed on a surface of the temperature detection circuit.

5. The combustor according to claim 1, wherein
the contact point includes
a hot contact point that is formed by connecting the positive element line and the negative element line in this order from the starting point side toward the end point side of the temperature detection circuit, and
a cold contact point that is formed by connecting the negative element line and the positive element line in this order from the starting point side toward the end point side of the temperature detection circuit,
a pair of the contact points are disposed to face each other so that the premixing pipe is interposed therebetween, and
the pair of contact points are either the hot contact points or the cold contact points.

6. (canceled)

7. The combustor according to claim 1, further comprising:
a plurality of nozzle segments configured by collectively disposing the plurality of premixing pipes, wherein
the temperature detection circuit is provided for each of the plurality of nozzle segments.

8. A combustor system comprising:
the combustor according to claim 1; and
a calculation device that detects flashback based on a voltage value output from the output terminal.

9. A combustor system comprising:
the combustor according to claim 1; and
a calculation device that calculates detection of in which region between a plurality of the output terminals flashback has occurred based on a voltage value output from the plurality of output terminals.

10. A combustor system comprising:
the combustor according to claim 7; and
a calculation device that identifies the nozzle segment in which flashback has occurred based on a voltage value output from the output terminal of each of the temperature detection circuits.

11. The combustor system according to claim 10, further comprising:
a fuel supply unit that is capable of regulating an amount of a fuel supplied to each of the nozzle segments, wherein
the calculation device decreases an amount of the fuel supplied to the nozzle segment identified that the flashback has occurred and increases an amount of the fuel supplied to the other nozzle segments.

12. A gas turbine comprising:
the combustor system according to claim 8, into which air is introduced to generate a combustion gas;
a compressor that supplies the compressed air to the combustor system; and
a turbine that is driven by the combustion gas.
